(19) United States
(12) Patent Application Publication
(10) Pub. No.: US 2023/0097495 A1
(43) Pub. Date: Mar. 30, 2023

(54) SIMULATED TISSUE STRUCTURE COMPOSITION AND USE FOR SURGICAL TRAINING

(71) Applicant: Applied Medical Resources Corporation, Rancho Santa Margarita, CA (US)

(72) Inventors: Oscar Raygan, Rancho Santa Margarita, CA (US); Brannon Smudz, Rancho Santa Margarita, CA (US)

(21) Appl. No.: 17/950,451

(22) Filed: Sep. 22, 2022

Related U.S. Application Data
(60) Provisional application No. 63/249,692, filed on Sep. 29, 2021.

(51) Int. Cl. G09B 23/34; B29C 70/30

(52) U.S. Cl. CPC G09B 23/34; B29C 70/30; B29K 2083/00

(57) ABSTRACT

A simulated tissue structure and a method for making the same is provided. The simulated tissue structure is made to have a longitudinal strength that is sufficient to withstand manipulations and movements when used with a simulated surgical training model while still being severable by conventional and electro-surgical tools. The simulated tissue structure has a first and second inner layer that is encompassed by an outer layer. Portions of the first inner layer are connectable with other simulated organs to simulate conditions for training laparoscopic procedures.

This application claims priority to and benefit of U.S. Provisional Patent Application Ser. No. 63/249,692 entitled “Simulated Tissue Structure Composition and Use for Surgical Training” filed on Sep. 29, 2021 which is incorporated herein by reference in its entirety.

### FIELD OF INVENTION

This application is generally related to surgical training tools, and in particular, to simulated tissue structures and models for teaching and practicing various surgical techniques and procedures related but not limited to laparoscopic, endoscopic and minimally invasive surgery.

### BACKGROUND OF INVENTION

Medical students as well as experienced doctors learning new surgical techniques must undergo extensive training before they are qualified to perform surgery on human patients. The training must teach proper techniques employing various medical devices for cutting, penetrating, clamping, grasping, stapling, cauterizing and suturing a variety of tissue types. The range of possibilities that a trainee may encounter is great. For example, different organs and patient anatomies and diseases are presented. The thickness and consistency of the various tissue layers will also vary from one part of the body to the next and from one patient to another. Different procedures demand different skills. Furthermore, the trainee must practice techniques in various anatomical environs that are influenced by factors such as the size and condition of the patient, the adjacent anatomical landscape and the types of targeted tissues and whether they are readily accessible or relatively inaccessible.

Numerous teaching aids, trainers, simulators and model organs are available for one or more aspects of surgical training. However, there is a need for models or simulated tissue elements that are likely to be encountered in and that can be used for practicing endoscopic and laparoscopic, minimally invasive, transluminal surgical procedures. In laparoscopic surgery, a trocar or cannula is inserted to access a body cavity and to create a channel for the insertion of a camera such as a laparoscope. The camera provides a live video feed capturing images that are then displayed to the surgeon on one or more monitors. At least one additional small incision is made through which another trocar/cannula is inserted to create a pathway through which surgical instruments can be passed for performing procedures observed on the monitor. The targeted tissue location such as the abdomen is typically enlarged by delivering carbon dioxide gas to insufflate the body cavity and create a working space large enough to accommodate the scope and instruments used by the surgeon. The insufflation pressure in the tissue cavity is maintained by using specialized trocars. Laparoscopic surgery offers a number of advantages when compared with an open procedure. These advantages include reduced pain, reduced blood and shorter recovery times due to smaller incisions.

Laparoscopic or endoscopic minimally invasive surgery requires an increased level of skill compared to open surgery because the target tissue is not directly observed by the clinician. The target tissue is observed on monitors displaying a portion of the surgical site that is accessed through a small opening. Therefore, clinicians need to practice visually determining tissue planes, three-dimensional depth perception on a two-dimensional viewing screen, hand-to-hand transfer of instruments, suturing, precision cutting and tissue and instrument manipulation. Typically, models simulating a particular anatomy or procedure are placed in a simulated pelvic trainer where the anatomical model is obscured from direct visualization by the practitioner. Ports in the trainer are employed for passing instruments to practice techniques on the anatomical model hidden from direct visualization. Simulated pelvic trainers provide a functional, inexpensive and practical means to train surgeons and residents the basic skills and typical techniques used in laparoscopic surgery such as grasping, manipulating, cutting, tying knots, suturing, stapling, cauterizing as well as how to perform specific surgical procedures that utilized these basic skills. Simulated pelvic trainers are also effective sales tools for demonstrating medical devices required to perform these laparoscopic procedures.

One procedure is a hysterectomy in which the uterus is removed. The hysterectomy may be performed vaginally extracting the uterus through the vaginal canal or abdominally through a small incision in the abdomen. The vaginal hysterectomy is historically hard to train on as the field of view is limited. Unlike laparoscopic procedures, there is no camera that is projecting the surgery onto a screen and unlike open procedures there is not a wide incision that can be viewed by multiple people. As such, the best way to teach a vaginal hysterectomy is through a simulated model. Therefore, there is a need for model for training hysterectomy procedures. Furthermore, the simulated model can also be configured to provide additional teaching scenarios, for example, simulating removal of the uterus through an abdominal approach.

### SUMMARY OF THE INVENTION

In accordance with various embodiments, a simulated tissue structure is described herein. In particular, the simulated tissue structure can be used to simulate one or more different types of ligaments. The simulated tissue structure described herein has a first inner layer, a second inner layer, and an outer layer that surrounds both the first and second inner layers. The first and second layers provide longitudinal strength for the simulated tissue structure when used for surgical simulations.

In accordance with various embodiments of the present invention, a method for making a simulated tissue structure is described herein. The method includes providing a mold which has a proximal and a distal end and a cavity which extends between the proximal and distal ends. The method also includes using mesh fabric and yarn. The mesh fabric is first arranged within the mold and is conformed to the shape of the cavity of the mold. After the mesh fabric is arranged, the mold is partially filled with silicone which covers at least a portion of the mesh fabric within the cavity. The yarn is then arranged onto the silicone. The mold is subsequently further filled with silicone which covers the yarn. The silicone within the mold is then allowed to cure thereby encasing both the mesh fabric and the yarn forming a silicone structure that has enhanced longitudinal strength when used for surgical simulations.

In accordance with various embodiments, a simulated tissue structure is described herein. The simulated tissue structure can be used to simulate, for example, various types of ligaments. The simulated tissue structure has a first layer, a second layer, and an outer layer that surrounds both the first and second inner layers. Each of the first, second, and outer layers are made from materials different from each other. Based on the materials used for the first and second layers, different longitudinal strengths can be provided for the simulated tissue structure.

In accordance with various embodiments, a simulated tissue structure is described herein. The simulated tissue structure has a first layer, a second layer, and an outer layer that surrounds both the first and second inner layers. The outer layer has a longitudinal strength that is weaker than the first layer or the second layer.

### BRIEF DESCRIPTION OF THE DRAWINGS

The present inventions may be understood by reference to the following description, taken in connection with the accompanying drawings in which the reference numerals designate like parts throughout the figures thereof.

FIG. 1 is a back view of a simulated surgical training model in accordance with various embodiments of the present invention.

FIG. 2 is a top view of a simulated surgical training model in accordance with various embodiments of the present invention.

FIG. 3 is a side view of a simulated surgical training model in accordance with various embodiments of the present invention.

FIG. 4 is a back view of portions of a simulated surgical training model in accordance with various embodiments of the present invention.

FIG. 5 is a back view of a simulated surgical training model in accordance with various embodiments of the present invention.

FIG. 6 is a back view of a simulated surgical training model in accordance with various embodiments of the present invention with a portion of the model removed.

FIG. 7 is a side view of portions of a simulated surgical training model in accordance with various embodiments of the present invention.

FIG. 8 is a side view of a simulated tissue structure in accordance with various embodiments of the present invention.

FIG. 9 is a cross-sectional view of a simulated tissue structure in accordance with various embodiments of the present invention.

FIG. 10 is a perspective view of a surgical training device in accordance with various embodiments of the present invention.

### DETAILED DESCRIPTION OF THE INVENTION

In accordance with various embodiments of the present invention a simulated surgical training model is provided. The simulated surgical training model comprises one or more artificial or simulated tissue structures comprising an interlaced planar threaded material, a continuous length of fibers or filament and/or curable silicone. The simulated tissue structure is connectable to an artificial or simulated organ, bone, tissue layer and/or any combination thereof. The simulated tissue structure has a column or longitudinal strength sufficient to withstand manipulations and movement within the simulated surgical training procedures while simultaneously being severable by a conventional surgical scissor, scalpel, or the like. The simulated tissue structure is suturable, i.e., able to withstand and hold a suture and/or the process or manipulations involved in suturing of the simulated tissue structure to itself and/or a separate simulated organ or tissue.

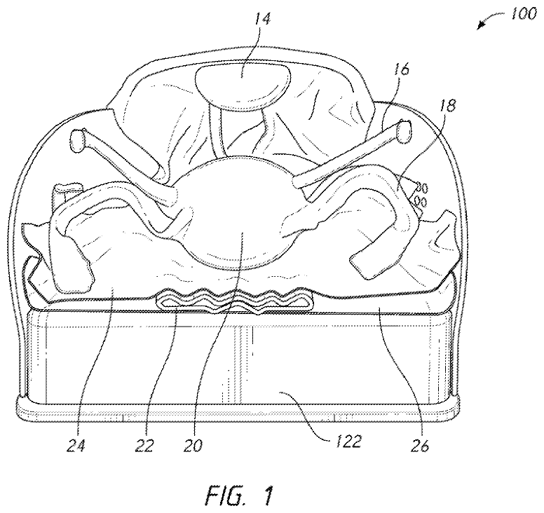

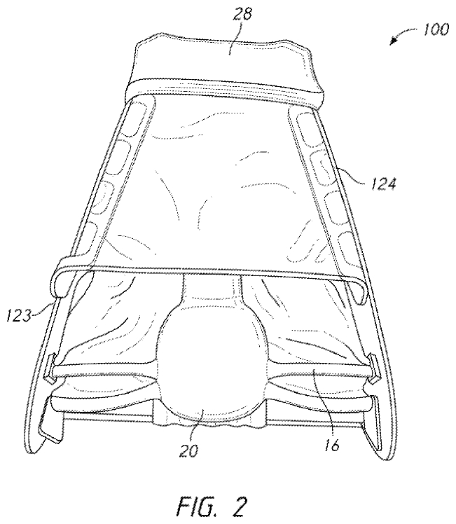

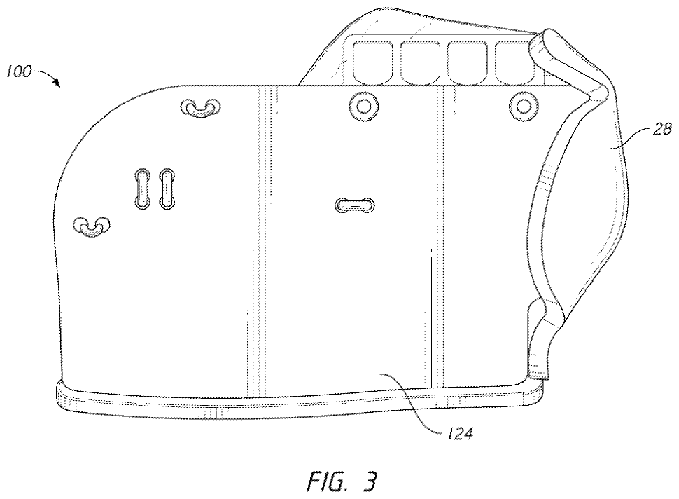

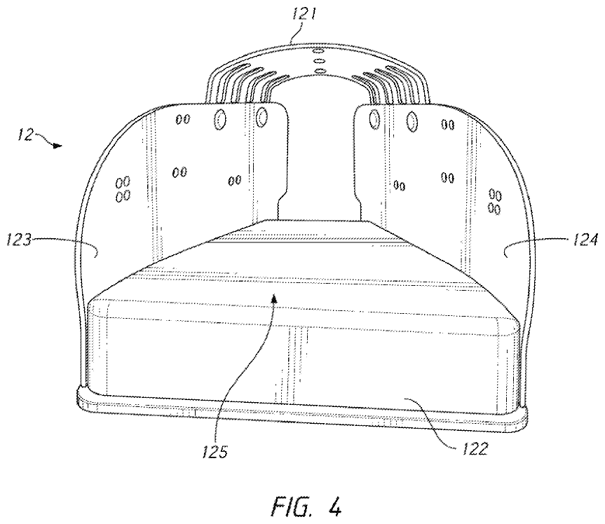

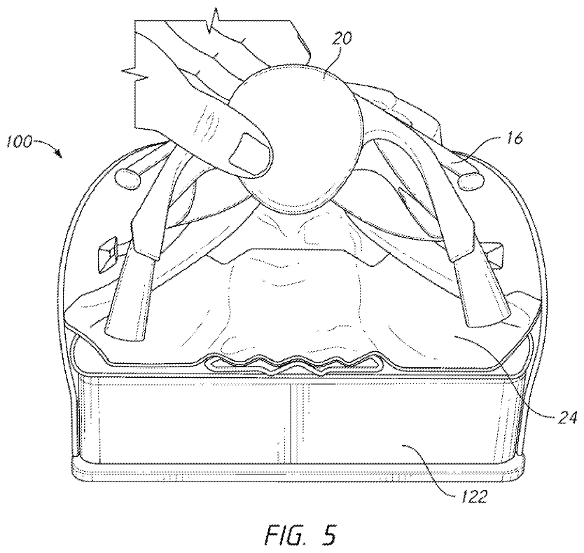

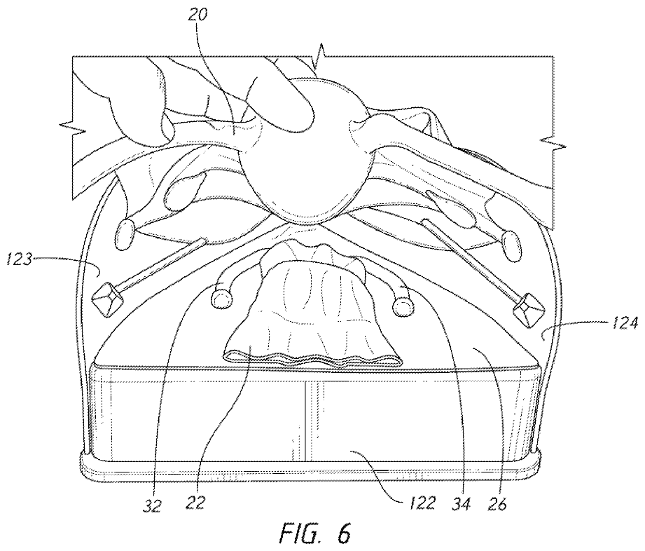

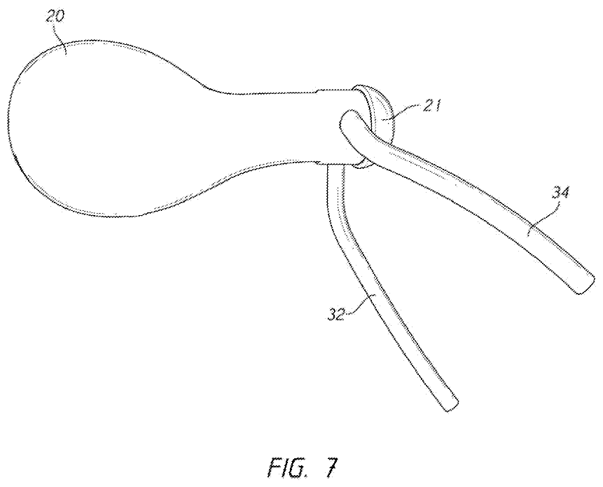

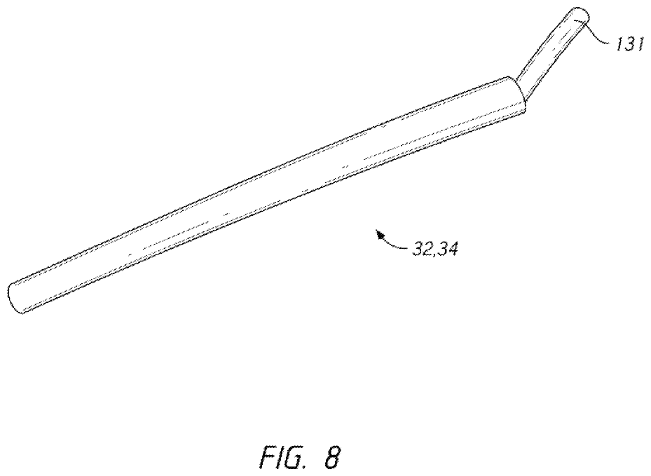

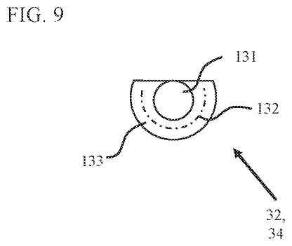

Referring to FIGS. 1-9, a simulated surgical training model 100 having one or more simulated tissue structures is provided. In various embodiments, the simulated surgical model 100 comprises a simulated pelvic frame 12. The frame 12 comprises a top cover 121 and a base 122 connected to each other by sidewalls 123, 124 and collectively defining a cavity 125. The frame 12 is tapered having a proximal end smaller than a distal end. Connected to the frame 12 are simulated organs, simulated tissue layers, and simulated tissue structures, such as connective tissue and/or vasculature, including ligaments, vessels and the like. As shown in the illustrated embodiment, a simulated bladder 14, a simulated uterus 20 and a simulated colon 22, all of which are disposed within the cavity 125 of the frame 12. The simulated bladder 14 is a hollow, air-filled component which can be made of silicone or any other type of elastomeric material. The simulated bladder 14 is connected to the top cover 121 of the frame 12 while the simulated colon 22 is connected to the base 122 of the frame 12. In various embodiments, the simulated bladder 14 is a closed receptacle with an outer membrane made of pink-colored silicone. The interior of the simulated bladder 14 may be filled with air, polyfil or other material to maintain its shape. In some embodiments, the simulated bladder 14 may also be filled with a liquid.

The simulated uterus 20 is disposed between the simulated bladder 14 and the simulated colon 22 with the simulated uterus 20 suspended within the frame 12. In various embodiments, the simulated uterus 20 has a bulbous portion defining a hollow simulated uterine cavity (not shown). The bulbous portion is connected to a tubular portion defining a vaginal canal. The simulated uterus 20 can also include simulated fallopian tubes that are connected to simulated ovaries, which are oval-shaped structures made of silicone and filled. In various embodiments, the simulated uterus 20 is made of silicone and/or foam. The simulated uterus 20 is connected and suspended from the frame 12 via simulated vasculature 16. The simulated vasculature 16 is made of solid or hollow tubular silicone or other suitable elastomer. Liquid may be included inside the hollow tubing of the simulated vasculature 16. Proximate to the simulated vasculature 16 are simulated fallopian tubes 18 connected to and extending from the simulated uterus 20. The simulated fallopian tubes 18 have a tubular/cylindrical form and can be made of silicone or other elastomeric material or may include materials such as foam combined with the silicone. Disposed between the simulated uterus 20 and the simulated colon 22 is a simulated peritoneum layer 24. The simulated peritoneum layer 24 covers the simulated colon 22. Disposed under the simulated colon 22 is a simulated pelvic floor 26 connected to the base 122 of the frame 12. The simulated colon 22 is a tubular structure that has a lumen extending lengthwise therethrough. In various embodiments, the simulated colon/rectum 22 is a tubular structure made of silicone with molded transverse folds and in various embodiments, the simulated peritoneum layer 24 and/or the simulated pelvic floor 26 comprises a flat planar layer of silicone material. The simulated colon 22 can be made of silicone or other elastomeric material and can be color pink or other suitable color.

Connected to the simulated uterus 20 at its proximal end is at least one simulated tissue structure and in the illustrated embodiment, comprises a simulated uterosacral ligament 32 or 34. The simulated uterosacral ligament 32 or 34 comprises an interlaced planar threaded material and a continuous length of fibers or filaments embedded in silicone. In various embodiments, the simulated uterosacral ligament 32 or 34 comprises an elongate monolithic structure of silicone in which mesh fabric and yarn are embedded therein. In various embodiments, the simulated uterosacral ligament 32 or 34 comprises a first inner layer 131 proximate a second inner layer 132 both of which are surrounded or encased within an outer layer 133. The first inner layer 131 and the second inner layer 132 are made of different materials and have different longitudinal and/or transverse strengths relative to each other. In various embodiments, the first inner layer 131 has a length longer than the second inner layer 132 and/or a thickness greater than the second inner layer 132. The outer layer 133 has a length shorter than the first inner layer 131 and/or a longitudinal and/or transverse strength weaker than the first inner layer 131 and/or the second inner layer 132.

In accordance with various embodiments, a simulated cervix 21 is connected to the simulated uterus 20 and the simulated uterosacral ligaments 32, 34 are connected to the simulated cervix 21. The simulated cervix 21 includes an opening extending into a cavity defined by the simulated uterus 20. A simulated vaginal canal (not shown) connects the simulated uterus 20 and the simulated cervix 21 to a simulated vaginal opening 28 that is attached and encloses the proximal end of the frame 12. The simulated vaginal canal (not shown) is a tubular structure having a proximal and a distal end. The simulated vaginal canal is made of silicone and may optionally contain an embedded mesh layer that, in various embodiments, may assist in the connection and/or suspension effect of the simulated uterosacral ligaments. The simulated vaginal canal is connected to the simulated uterus 20 at one end and has the simulated vaginal opening 28 located at the opposite end of the simulated vaginal canal. The simulated cervix 21 is a tubular structure that is made of silicone and has an opening at a proximal end. In various embodiments, the simulated cervix 21 has a mesh material for reinforcement. The end of the simulated uterosacral ligament 32 or 34, i.e., the end not connected to the simulated cervix 21, is connected to the simulated pelvic floor 26 via, for example, adhesive. The simulated pelvic floor 26 is connected to the base 122 of frame 12 via, for example, adhesive. In various embodiments, the simulated vaginal canal (not shown) is a tubular structure made of silicone.

In various embodiments, the frame 12 is configured to simulate a pelvis and serve as a box-like encasement for housing the plurality of simulated organ and tissue structures. The frame 12 comprises a plurality of pieces of semi-rigid plastic with portions connected to each other with fasteners and/or adhesive. The area of the central lumen or cavity 125 in cross-section taken perpendicular to the longitudinal axis increases progressively with increasing distance from the proximal end toward the distal end. The frame 12 has a base 122, permitting it to be placed and stood on a flat surface. The frame 12 may include apertures for passing of fasteners and/or connecting tissue structures, such as simulated vasculatures 16, by passing them through and looping around the apertures and suspending them in the frame 12. Similar to other portions of the simulated surgical training model, the frame 12 includes portions thereof that are representative of a pelvis that is not anatomically correct yet provides advantages needed in simulating laparoscopic procedures in exchange for the realism of an anatomically correct pelvis. The physical constriction of organs at the proximal end creates a more rigid response in the organs when manipulated by surgical instruments relative to the distal end where organs located therein are less constricted and freer to pendulate and more fluidly respond to manipulations with surgical instruments. Similar to other portions of the simulated surgical training model or the model in general, the frame 12 in accordance with various embodiments is an intentional simplification of the pelvis that combines variable resistance in the organs along the length of the longitudinal axis of the central lumen. The smaller opening to the central lumen at the proximal end of the frame 12 is where the opening to the vaginal canal would be positioned when the organs are placed inside the frame 12. The distal end of the frame 12 is where the location of the simulated uterus 20 may be positioned. Other simulated tissue structures or portions thereof may also be included at or near the distal end of the frame 12 such as ovarian ligaments, ovarian vessels, ureters, peritoneum, colon, and fallopian tubes. In various embodiments, the ovarian ligaments, ovarian vessels, the ureters, and the fallopian tubes are tubular structures having a circular cross-section and made of silicone that facilitates connections with other silicone-based structures via a silicone-to-silicone connection. Furthermore, the ovarian ligaments, ovarian vessels, the ureters, and the fallopian tubes can be partially or entirely hollow or solid. The central lumen of the frame 12 expands, widens and angles outwardly towards the distal end. This taper of the box-like frame widens relaxing the organs located therein and the narrow proximal end constricts the organs, limiting the range of motion of the organs relatively more as a result of supporting the organs in closer confines.

In various embodiments, the simulated pelvic floor 26 serves as a location for easy silicone-to-silicone attachment; wherein silicone-to-plastic attachment is more difficult to accomplish. Silicone adheres to silicone easily and removal of a silicone organ structure from the frame 12 is simplified with the simulated pelvic floor 26. The simulated pelvic floor 26 is not an anatomically correct component of the human anatomy. Therefore, this model is not an accurate reproduction of human anatomy. Nevertheless, the appearance of the model maintains anatomical integrity for the user during procedural training employing laparoscopic techniques. The simulated pelvic floor 26 creates a background for the user. This backdrop does not detract from the realism that is significant to user such as the simulated organs placed onto or attached to the backdrop of the simulated pelvic floor 26.

In various embodiments, the simulated tissue structures are connected to the frame 12 via adhesion to supportive structures. The apertures in the frame 12 in various embodiments are used to create a mechanical connection between simulated tissue structures and the frame 12 utilizing tissue sheets and/or silicone as a mechanical link. Some of the tissue sheets or silicone involved in such connections may not be anatomically correct and may only be used for structural and/or aesthetic purposes. In various embodiments, the top cover or roof of the frame 12 disposed opposite to the base and/or the pelvic floor does not include apertures or holes at or near the sides or bends of the roof adjacent to the sidewalls of the frame to enhance the durability and/or robustness of the connection therebetween and the roof thereby, e.g., decreasing potential breakage or disconnections during shipping.

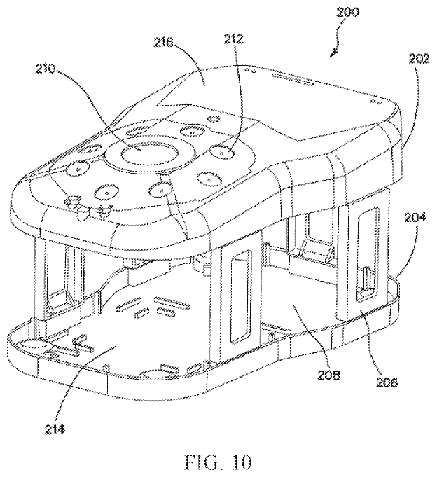

Referring to FIG. 10, a laparoscopic surgical training device 200 according to various embodiments is shown. The laparoscopic surgical training device 200 provides an internal cavity 208 substantially obscured from the user for receiving simulated or live tissue or model organs or training models of the like described in this invention. The body cavity 208 is accessed via a tissue simulation region 210 that is penetrated by the user employing devices to practice surgical techniques on the tissue or practice model found located in the body cavity 208. Although the internal cavity 208 is shown to be accessible through a tissue simulation region 210, a hand-assisted access device, trocar, or single-site port device may be alternatively employed to access the internal cavity 208. An exemplary laparoscopic surgical training device is described in U.S. Pat. No. 8,764,452 entitled “Portable Laparoscopic Trainer” filed on Sep. 29, 2011 and incorporated herein by reference in its entirety. The laparoscopic surgical training device 200 is particularly well suited for practicing laparoscopic or other minimally invasive surgical procedures.

The laparoscopic surgical training device 200 includes a top cover 202 connected to and spaced apart from a base 204 by a plurality of legs 206. The laparoscopic surgical training device 200 is configured to mimic the torso of a patient such as the abdominal region. The top cover 202 is representative of the anterior surface of the patient and the space between the top cover 202 and the base 204 is representative of an interior of the patient or body cavity where organs reside. The laparoscopic surgical training device 200 is a useful tool for teaching, practicing, and demonstrating various surgical procedures and their related instruments in simulation of a patient undergoing a surgical procedure. Surgical instruments are inserted into the cavity through the tissue simulation region 210 as well as through pre-established apertures 212 in the top cover 202. Various tools and techniques may be used to penetrate the top cover 202 to perform mock procedures on simulated organs or practice models placed between the top cover 202 and the base 204. The base 204 includes a model-receiving area 214 or tray (not shown) for staging or holding a simulated tissue model or live tissue. To help retain a simulated tissue model, the tissue model may include a patch of hook-and-loop type fastening material affixed to the base 204 in the model receiving area 214 such that it is removably connectable to a complementary piece of hook-and-loop type fastening material affixed to the tissue or organ model. A video display monitor 216 is hinged to the top cover 202 (shown in a closed orientation in FIG. 10). The video monitor 216 is connectable to a variety of visual systems for delivering an image to the monitor. For example, a laparoscope inserted through one of the pre-established apertures 212 or a webcam located in the cavity and used to observe the simulated procedure can be connected to the video monitor 216 and/or a mobile computing device to provide an image to the user.

When assembled, the top cover 202 is positioned directly above the base 204 with the legs 206 located substantially around the periphery and interconnected between the top cover 202 and base 204. The top cover and base are substantially the same shape and size and have substantially the same peripheral outline. The internal cavity is partially or entirely obscured from view. In the illustrated embodiment, the legs include openings to allow ambient light to illuminate the internal cavity and/or to provide weight reduction for convenient portability. The top cover is removable from the legs which in turn are removable or collapsible via hinges or the like with respect to the base. The surgical trainer 200 provides a simulated body cavity 208 that is obscured from the user. The internal or body cavity 208 is configured to receive at least one simulated surgical training model in which the user may access the model to practice laparoscopic or endoscopic minimally invasive surgical techniques.

In use, in various embodiments, a simulated surgical training model 100, for example, is placed inside a laparoscopic trainer 200. In various embodiments, the inserted model is accessible via a vaginal opening and in various embodiments, is configured for simulating transvaginal surgery including transvaginal hysterectomies. In various embodiments, the aperture of the vaginal opening is circular in shape. In other various embodiments, the aperture is elongate elliptical, oval-like in shape and oriented vertically or perpendicularly to the longitudinal axis of the vaginal opening.

In various embodiments, a user of a simulated surgical model may approach the simulated uterus 20 with surgical instruments and retractors through the vaginal opening to perform a transvaginal hysterectomy. Alternatively, the simulated uterus 20 may be approached through the simulated abdominal wall of the top cover 202 of the trainer 200. The user can practice laparoscopic surgical skills, employing a trocar and scope to examine the anatomy and perform the simulated surgical hysterectomy. The procedure, in various embodiments, involves making key incisions to detach the uterus and then remove it. In various embodiments, an incision inside the simulated vaginal canal around the simulated cervix 21 can be made to begin mobilization of the simulated uterus. The simulated uterosacral ligaments 32 or 34 having sufficient longitudinal and transverse strength can be manipulated and cut out from both sides of the simulated cervix 21, sutured and held outside the frame 12 to be sutured later to the simulated vaginal canal to prevent the collapse of the simulated vaginal canal. The simulated uterus 20 can be further released from other simulated tissue and extracted out through the simulated vaginal canal. The simulated uterosacral ligaments 32 or 34 again having sufficient longitudinal and transverse strength can be manipulated and sutured to the simulated vaginal canal.

In accordance with various embodiments, a method of making a simulated tissue structure, such as connective tissue and/or vasculature, including ligaments, vessels, and the like, and, for example, simulated uterosacral ligaments 32, 34, is provided. The method includes the step of providing a mold having a proximal end, a distal end and a cavity extending between the proximal and distal end. The method comprises providing at least one mesh fabric and at least one yarn. In various embodiments, the mesh fabric has a predetermined width and length and the yarn has a length and thickness greater than the mesh fabric. The method comprises arranging and/or conforming the mesh fabric to along the cavity of the mold. The mesh fabric in various embodiments is arranged to be curved or bowed along its length and thus having a curved cross-section. The method further comprises filling or injecting silicone into the mold with the mesh fabric inserted within the cavity. The silicone is filled to cover the mesh fabric while not filling up the entire cavity of the mold. The method further comprises placing the yarn on the silicone, centering the yarn relative to the cavity, and adding or injecting in additional silicone on top of and around the yarn. The silicone is cured or allowed to cure. In various embodiments, the yarn and mesh fabric are thereby encased, embedded, or enclosed within the silicone. As such, in accordance with various embodiments, simulated tissue structures, such as connective tissue and/or vasculature, including ligaments, vessels and the like, providing enhanced longitudinal and transverse strength can be made. In various embodiments, a proximal or distal portion of the yarn is not covered or encased in silicone and/or in various embodiments, a proximal/distal portion of the yarn extends beyond the proximal/distal end of the mold. In various embodiments, an electroconductive material, e.g., an electroconductive hydrogel, can be used in addition to or instead of the silicone.

In accordance with various embodiments, the exposed yarn, e.g., the yarn not covered by silicone, of the simulated tissue structure are inserted into a simulated organ mold, e.g., a cervix mold. In accordance with various embodiments, one or more simulated tissue structures are inserted into one or more openings or channels within the simulated organ mold. The simulated organ mold is filled with silicone, covering, and encasing the inserted portion of one or more simulated tissue structures. The silicone is cured or allowed to cure, thereby connecting a simulated organ or a portion thereof, e.g., a simulated cervix, to one or more simulated tissue structures, e.g., a simulated uterosacral ligament. In various embodiments, another simulated organ or portion thereof is provided and connected to one or more simulated organs and/or tissue structures. For example, a pre-formed uterus is inserted into the cervix mold with the inserted portion of one or more simulated tissue structures and the silicone. The silicone is cured or allowed to cure, thereby connecting simulated organs or portions thereof to the one or more simulated tissue structures. For example, a simulated uterus, a simulated cervix and simulated uterosacral ligaments are connected together.

In various embodiments, a simulated tissue structure, such as a simulated uterosacral ligament 32 or 34, is provided and comprises an interlaced planar threaded material and a continuous length of fibers or filaments embedded in silicone. In various embodiments, a simulated tissue structure, such as a simulated uterosacral ligament 32 or 34, is provided and comprises a first inner material or layer 131, a second inner material or layer 132 and an outer layer 133 or material. In various embodiments, the first inner material or layer 131, the second inner material or layer 132, and the outer material or layer 133 are different or not the same material. In various embodiments, the first inner material or layer 131 comprises yarn, twine, thread, cord, string, strap, strand, fiber, cable and/or any combination thereof. In various embodiments, the second inner material or layer 132 comprises mesh fabric, Tulle®, Kevlar®, fiberglass mesh, neoprene mesh, netting, webbing, lattice, screen, and/or any combination thereof. In various embodiments, the outer material or layer 133 comprises non-conductive silicone, conductive hydrogel, or other conductive material, and/or any combination thereof.

In various embodiments, mesh fabric and yarn are embedded in silicone to provide a durable or enhanced material strength of a ligament, vasculature, and/or other anatomical or surgical models used in various simulated surgical procedures. In accordance with various embodiments, the artificial or simulated tissue structure comprises one or more portions of yarn extending through or embedded in the simulated tissue structure to enhance the longitudinal strength of the simulated tissue structure. In accordance with various embodiments, the simulated tissue structure comprises one or more portions of mesh extending through or embedded in the simulated tissue structure to enhance the longitudinal and transverse strength of the simulated tissue structure.

Various portions in accordance with various embodiments of a simulated organ and/or vasculatures can be made of one or more organic base polymer including but not limited to hydrogel, single-polymer hydrogel, multi-polymer hydrogel, rubber, latex, nitrile, protein, gelatin, collagen, soy, non-organic base polymer such as thermo plastic elastomer, KRATON polymer, silicone, foam, silicone-based foam, urethane-based foam and ethylene vinyl acetate foam and the like. Into any base polymer one or more filler may be employed such as a fabric, woven or non-woven fiber, polyester, nylon, cotton and silk, conductive filler material such as graphite, platinum, silver, gold, copper, miscellaneous additives, gels, oil, cornstarch, glass, dolomite, carbonate mineral, alcohol, deadener, silicone oil, pigment, foam, poloxamer, collagen, gelatin and the like. The adhesives employed may include but are not limited to cyanoacrylate, silicone, epoxy, spray adhesive, rubber adhesive and the like.

In accordance with various embodiments, the simulated surgical training model includes portions, such as simulated tissue structures, layers and/or organs that not anatomically correct yet provides structure needed or helpful in simulating surgical, e.g., laparoscopic, procedures, in exchange for, for example, anatomical accuracy. Similarly, in accordance with various embodiments, the simulated surgical training model provides an intentional simplification, e.g., not including tissue, organs or the like, typically found in a patient, to emphasize and/or provide repeatable, consistent and practicable surgical training models to assist in simulating, training and evaluating surgical procedures.

The above description is provided to enable any person skilled in the art to make and use the present invention and perform the methods described herein and sets forth the best modes contemplated by the inventors of carrying out their inventions. Various modifications, however, will remain apparent to those skilled in the art. It is contemplated that these modifications are within the scope of the present disclosure. Different embodiments or aspects of such embodiments may be shown in various figures and described throughout the specification. However, it should be noted that although shown or described separately each embodiment and aspects thereof may be combined with one or more of the other embodiments and aspects thereof unless expressly stated otherwise. It is merely for easing readability of the specification that each combination is not expressly set forth.

Although the present invention has been described in certain specific aspects, many additional modifications and variations would be apparent to those skilled in the art. It is therefore to be understood that the present invention may be practiced otherwise than specifically described, including various changes in the size, shape and materials, without departing from the scope and spirit of the present invention. Thus, embodiments of the present invention should be considered in all respects as illustrative and not restrictive.

1. A simulated tissue structure comprising:
a first inner layer;
a second inner layer; and
an outer layer surrounding the first inner layer and the second inner layer,
wherein the first inner layer and the second inner layer are configured to provide a longitudinal strength for the simulated tissue structure.

2. The simulated tissue structure of claim 1, wherein the first inner layer comprises one or more of yarn, twine, threads, cords, strings, straps, strands, fibers, or cables.

3. The simulated tissue structure of claim 1, wherein the second inner layer comprises one or more of mesh fabric, Tulle®, Kevlar®, fiberglass mesh, neoprene mesh, netting, webbing, lattice, or screens.

4. The simulated tissue structure of claim 1, wherein the outer layer comprises a non-conductive silicone.

5. The simulated tissue structure of claim 1, wherein a portion of the first inner layer extends past the outer layer and is configured to connect with other simulated organs.

6. The simulated tissue structure of claim 1, wherein the first inner layer has a length longer than the second inner layer.

7. The simulated tissue structure of claim 1, wherein the first inner layer has a thickness greater than the second inner layer.

8. The simulated tissue structure of claim 1, wherein the outer layer comprises a conductive material.

9. A method for making a simulated tissue structure, comprising:
providing a mold having a proximal end, a distal end, and a cavity extending between the proximal end and the distal end;
providing at least one mesh fabric;
providing at least one yarn;
arranging the at least one mesh fabric to conform to the cavity of the mold;
partially filling the mold with silicone thereby covering the at least one mesh fabric;
arranging the at least one yarn onto the silicone;
filling the mold with silicone over the at least one yarn; and
curing the silicone within the mold to form a silicone structure having the at least one mesh fabric and the at least one yarn encased therein.

10. The method of claim 9, wherein the at least one yarn has a length and a thickness that is greater than a length and thickness of the at least one mesh fabric.

11. The method of claim 9, wherein the at least one mesh fabric is configured to be curved along its length thereby having a curved cross-section.

12. The method of claim 9, wherein the at least one yarn is centered relative to the cavity.

13. The method of claim 9, wherein a portion of the at least one yarn is not covered by the silicone.

14. The method of claim 13, wherein a portion of the at least one yarn extends beyond the proximal end and/or the distal end of the mold.

15. The method of claim 14, further comprising inserting the portion of the at least one yarn that extends beyond the proximal and/or the distal end of the mold into one or more openings of one or more simulated organ molds thereby connecting the silicone structure to other simulated organs.

16. The method of claim 9, further comprising adding an electroconductive material with the silicone to the mold.

17. The method of claim 16, wherein the electroconductive material is an electroconductive hydrogel.

18. A simulated tissue structure comprising an elongate tube comprising an interlaced planar threaded material and a continuous length of fibers embedded in silicone.

19. The simulated tissue structure of claim 18 further comprising a simulated uterus comprising silicone and at least a portion of the continuous length of fibers is connected to the silicone of the simulated uterus.

20. The simulated tissue structure of claim 18 wherein the interlaced planar threaded material has a longitudinal strength different than the continuous length of fibers.

21. The simulated tissue structure of claim 18 wherein the silicone of the simulated tissue structure has a longitudinal strength weaker than the interlaced planar threaded material.

22. The simulated tissue structure of claim 18, wherein the continuous length of fibers has at least one of a length longer than the interlaced planar threaded material or a thickness greater than the interlaced planar threaded material.
